(19) United States
(12) Patent Application Publication
(10) Pub. No.: US 2024/0158277 A1
(43) Pub. Date: May 16, 2024

(54) GAS-BURNING FURNACE

(71) Applicant: ROCKWOOL A/S, Hedehusene (DK)

(72) Inventor: Lars Elmekilde HANSEN, Hedehusene (DK)

(21) Appl. No.: 18/550,334

(22) PCT Filed: Mar. 14, 2022
(86) PCT No.: PCT/EP2022/056474

§ 371 Date: Sep. 13, 2023

(30) Foreign Application Priority Data
Mar. 17, 2021 (EP) 21163056.1

(51) Int. Cl. C03B 5/235; C03B 5/12; F23C 5/32; F23L 7/00

(52) U.S. Cl. CPC C03B 5/2353; C03B 5/12; F23C 5/32; F23L 7/007

(57) ABSTRACT

The present invention provides an apparatus and a method for operating a cyclone combustion furnace using gaseous fuel.

### FIELD OF INVENTION

The invention is in the field of furnaces for melting mineral material, in particular for melting mineral material in a process for making fibres.

### BACKGROUND

Cyclone furnaces are established in the field of mineral melting processes.

Existing cyclone furnaces run solely or primarily on coal, or other solid or liquid fuel. Coal has particular benefits as the primary fuel in the process of operating a cyclone furnace because it makes a slow-burning flame. WO2014057130A1 allows for optional injection of a secondary gaseous fuel, making up less than 40% of the total fuel energy, in the lower end of a central region of the cyclone furnace to provide a flame there. The primary fuel used for melting mineral raw material is particulate.

U.S. Pat. No. 3,077,094 discloses a cyclone furnace in which air, gaseous fuel and optionally raw material are mixed together before entering the furnace. The gaseous fuel combusts quickly in this setup.

WO2016/092100A1 utilises a solid or liquid primary fuel for melting mineral raw material. A gaseous fuel can be used as a secondary fuel, co-injected with a particulate fuel at a lower section of the cyclone furnace than the primary fuel. This generates a stable flame in the lower section of the cyclone furnace, near to the melt pool, with the gaseous fuel combusting quickly and pre-heating the secondary particulate fuel. This set-up enables efficient use of cheaper fuels such as coal, whilst obtaining a high-quality melt. In WO2016/092100A1, particulate (i.e. solid or liquid) fuel is essential as the primary fuel, and gaseous fuel is only injected in a lower section of the cyclone furnace in combination with a particulate fuel.

EP 1 944 873 A1 discloses a cyclone furnace for melting mineral material, in which the primary fuel is particulate, especially coal. Only particulate fuel is injected at the top of the chamber and thus for the melting stage. Gaseous fuel is introduced in combination with particulate fuel in the lower section of the furnace, for the purpose of forming a flame above the melt pool. This flame is said to be advantageous for controlling the temperature of the melt pool and by extension the viscosity of the mineral melt leaving the furnace. However, particulate fuel is essential as the primary fuel in this document.

Although coal and other particulate fuels have been popular for use in cyclone furnaces for economic reasons, it would be desirable to use gaseous fuel as the sole or primary fuel to improve the environmental profile of the melting process. During development of the invention, a direct swap of particulate fuel for gaseous fuel using the same furnace setup was unsuccessful. Gaseous fuel burns much faster than particulate fuel and with a shorter flame than coal. A direct swap of particulate fuel for gaseous fuel resulted in blockage of fuel inlet ports due to slag formation, making the process unviable. The very fast burn rate of gaseous fuel results in near instantaneous sintering of mineral raw material, causing the undesirable inlet blockages.

It is an aim of the invention to provide the apparatus and method for using gaseous fuel in a cyclone furnace for producing mineral melt, thereby improving the environmental profile of the process whilst maintaining melt quality and apparatus longevity.

### SUMMARY

The invention provides a method for melting mineral material, the method comprising: providing a cyclone furnace, particulate mineral raw material, gaseous fuel, and oxidising agent; injecting gaseous fuel into the furnace at one or more first injection ports; injecting oxidising agent into the furnace at one or more second injection ports; injecting mineral raw material into the furnace at one or more third injection ports; allowing the gaseous fuel to combust with the oxidising agent, thereby melting the mineral raw material; characterised in that each first injection port is spaced at an angular separation from the one or more second injection ports such that no first injection port is at an angular separation of less than 20 degrees from any of the second injection ports, measured about a vertical axis through the centre of the cyclone furnace.

The invention also provides a cyclone furnace for melting mineral material using gaseous fuel as the sole or primary fuel, the furnace comprising: a furnace body having a body wall, a furnace lid, one or more first injection ports for injecting gaseous fuel into the furnace, one or more second injection ports for injecting oxidising agent into the furnace and one or more third injection ports for injecting mineral raw material into the furnace; wherein the furnace body comprises a top section, a central section and a bottom section; characterised in that the one or more first injection ports, the one or more second injection ports and the one or more third injection ports inject gaseous fuel, oxidising agent and mineral raw material, respectively, into the top section of the furnace, and in that each first injection port is spaced at an angular separation from the one or more second injection ports such that no first injection port is at an angular separation of less than 20 degrees from any of the second injection ports, measured about a vertical axis through the centre of the cyclone furnace.

The primary fuel of the invention is gaseous fuel. Gaseous fuel may be natural gas, biogas, shale gas or other available gas type, or a combination thereof. Preferably at least 60% of the energy in the method is derived from gaseous fuel, more preferably at least 80% of the energy. The sole fuel may be gaseous in the invention. This has the benefit of reducing or even eliminating particulate fuels such as coal, which improves the environmental profile of the method.

Additional burners, or electrodes for Joule heating, may be provided above or submerged within the melt pool. These burners or electrodes help to homogenise the mineral melt.

The oxidising agent may be air, oxygen, or oxygen-enriched air. Preferably oxygen-enriched air is used in the invention, which can be achieved by injecting oxygen into the air supply. Use of pure oxygen allows a smaller furnace volume but increases expense in this process, whereas air alone reduces expense but requires a larger furnace volume than oxygen-enriched air.

The mineral raw material is preferably particulate. Preferably the raw material particles have size in the millimetre scale. Preferably at least 99%, especially all, of the particles are smaller than 4 mm diameter and preferably 50% of particles by weight are smaller than 2 mm in diameter. The composition may be any glass, stone, or slag composition generally suitable for forming man-made vitreous fibres (MMVF). Preferably the composition of the fibres is in within the following parameters calculated as oxides in wt %:
SiO₂: at least 30, 32, 35 or 37; not more than 51, 48, 45 or 43
Al₂O₃: at least 14, 15, 16 or 18; not more than 35, 30, 26 or 23
CaO: at least 8 or 10; not more than 30, 25 or 20
MgO: at least 2 or 5; not more than 25, 20 or 15
FeO (including Fe₂O₃): at least 4 or 5; not more than 15, 12 or 10
FeO+MgO: at least 10, 12 or 15; not more than 30, 25 or 20
Na₂O+K₂O: zero or at least 1; not more than 10
CaO+Na₂O+K₂O: at least 10 or 15; not more than 30 or 25
TiO₂: zero or at least 1; not more than 6, 4 or 2
TiO₂+FeO: at least 4 or 6; not more than 18 or 12
B₂O₃: zero or at least 1; not more than 5 or 3
P₂O₅: zero or at least 1; not more than 8 or 5
Others: zero or at least 1; not more than 8 or 5

In the method the furnace may have a known construction for a cyclone furnace. In particular it may have a construction comprising a top section which is preferably substantially cylindrical, a central section which is preferably substantially frustoconical and a lower section which is preferably substantially cylindrical. A melt pool may be allowed to develop in the lower section, for collecting and fining the mineral melt.

Gaseous fuel, oxidising agent and mineral raw material are all preferably injected in or near to the top of the furnace.

Preferably each second injection port is integrated with a third injection port so that the oxidising agent and mineral raw material are injected together. In this case the gaseous fuel is separated from both the oxidising agent and the mineral raw material as it is injected.

The gaseous fuel is preferably injected through the lid of the furnace.

In the top section of the furnace there is preferably no additional fuel injected.

Additional gaseous fuel may be injected into the bottom section of the furnace, usually just above the melt pool, via further injection ports. The proportion of the energy for the method that is generated from the fuel that is injected through the first injection ports near the top of the furnace is usually at least 40%, preferably from 45 to 55%, in particular about 50%.

The mineral raw material and the oxidising agent are preferably injected through the side body wall of the furnace.

Each injection port for gaseous fuel is positioned at least 20 degrees away from any inlet for oxidising agent. This separation ensures that combustion and thereby heat release occurs sufficiently slowly. Angular separation is measured about a vertical axis through the centre of the furnace.

Injection of the gaseous fuel through the lid further facilitates separation of the gaseous fuel from the oxidising agent at the moment of injection into the furnace. This separation means that the gaseous fuel burns slower with controlled release of thermal energy such that the mineral raw material melts inside the furnace rather than sinters at the inlet which in turn could lead to blockage of the mineral material inlet. A further advantage to injecting the gaseous fuel through the lid rather than the side wall is that wear of the furnace interior walls is greatly reduced.

When the gaseous fuel is injected through the lid of the furnace, the gaseous fuel injector port may be at an angle of from 30° to 90° upwards from the lid. A lower angle is preferable for better mixing of the gaseous fuel with the mineral raw material and the oxidising agent, such that the gaseous fuel swirls through the air stream and burns in a controlled manner to melt the mineral raw material. A very low angle below 30° is not preferable because it requires a longer injection lance, especially when a thicker, water-cooled furnace lid is used.

The gaseous fuel and the gaseous oxidising agent may be provided in a stoichiometric or super-stoichiometric (surplus oxygen) ratio. A volume ratio of natural gas to oxygen-enriched air in the range 1:4 to 1:15, in particular 1:5 to 1:8 may be especially suited to the apparatus of the invention.

Gaseous fuel and oxidising agent may independently have injection speeds within the range 20 to 100 m/s, preferably 40 to 80 m/s. Particulate raw material may have an injection speed within the range 20 to 60 m/s, preferably 30 to 40 m/s.

### BRIEF DESCRIPTION OF DRAWINGS

FIG. 1 shows a schematic top view of a furnace in accordance with the invention.

FIG. 2 shows a schematic vertical cross section of the upper portion of a furnace in accordance with the invention.

FIG. 3 shows a schematic view of a furnace in accordance with the invention.

### DETAILED DESCRIPTION

An exemplary furnace in accordance with the invention is illustrated in the figures.

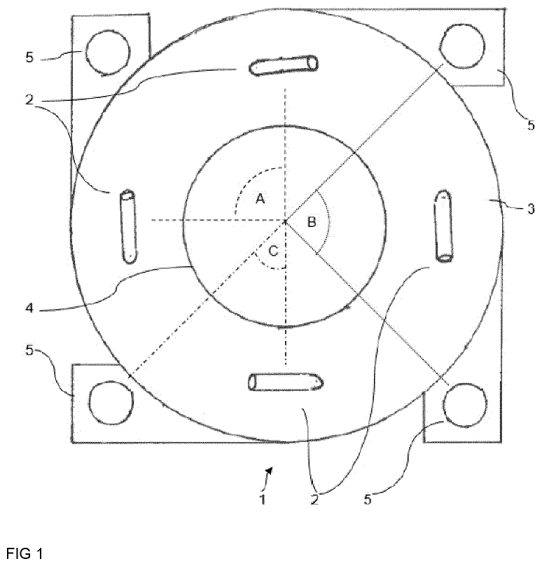

FIG. 1 shows a schematic top view of a furnace 1. Gaseous fuel injection ports 2 traverse the lid 3 of the furnace, which comprises an exhaust outlet 4 in the centre. Mineral raw material and oxidising agent (such as air or oxygen-enriched air) are injected into the furnace together via injection ports 5 located at the top of the side body wall of the furnace 1. The top of the furnace 1 being generally cylindrical, there exists a single, continuous side body wall.

The gaseous fuel injection ports 2 are spaced apart at equal angular distance from one another. The angular separation between the gaseous fuel injection ports 2 is shown as angle A in FIG. 1. In this case it is 90° because there are four such injection ports 2, equally spaced around the circumference of the furnace. The injection ports 5 for mineral raw material and oxidising agent are spaced at equal angular distance from one another. The angular separation between the injection ports 5 is shown as angle B in FIG. 1. In this case it is 90° because there are four such ports 5, equally spaced around the circumference of the furnace. It will be seen that each injection port 5 is spaced apart at an angular distance of at least 20 degrees from the nearest gaseous fuel injection port 2. The angular separation between each injection port and the closest gaseous fuel injection port 2 is shown as angle C and in this embodiment is about 45°. The angular separation is measured about a point in the centre of this schematic top view.

The mineral raw material, oxidising agent and gaseous fuel are injected tangentially into the furnace 1 and move in a circulating flow, at or approaching a cyclone system. The location and angle of the gaseous fuel injection ports 2 means that the gaseous fuel is injected into the stream of oxidising agent and mineral raw material, facilitating slower mixing and energy release such that the mineral raw material melts with the combustion of the gaseous fuel.

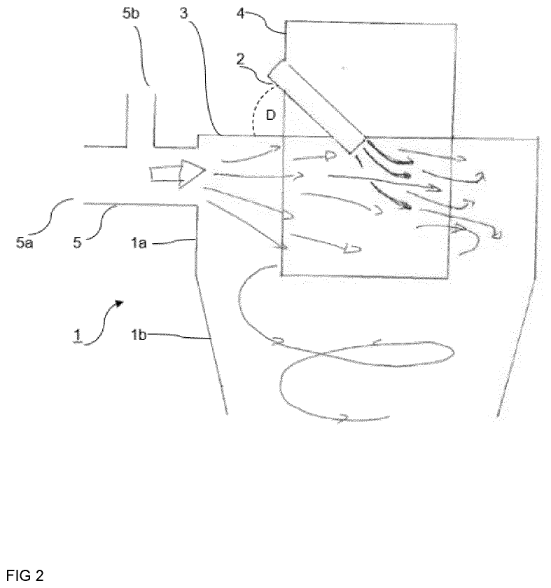

FIG. 2 shows a cross-sectional side view of a furnace 1 in accordance with the invention. Mineral raw material and oxidising agent (usually air, oxygen, or oxygen-enriched air) are injected together through port 5. Specifically, in this embodiment the oxidising agent enters through inlet 5a and mineral raw material through inlet 5b, and the two components enter the top section 1a of the furnace 1 together. Alternatively (not shown) the raw material may be injected through the lid 3 at a position adjacent the inlet for the oxidising agent. If oxygen-enriched air is used as the oxidising agent, this may be achieved by injecting oxygen into the air stream at inlet 5a.

The general direction of the flow of materials inside the furnace 1 is also shown in FIG. 2. The oxidising agent and the mineral raw material provide a stream into which gaseous fuel is injected via port 2, which traverses the lid of the furnace. Each of the injection ports 2 is positioned at an angle D of from 30 to 90 degrees from the lid of the furnace. This allows for delayed mixing so that the energy release from the burning of the fuel can melt the mineral raw material, whilst allowing the fuel to combust without being drawn out of the exhaust 4 prior to combustion. The circulating flow continues as the mineral material melts and falls down the furnace to the central section 1b and on to the bottom section 1c (not shown in FIG. 2).

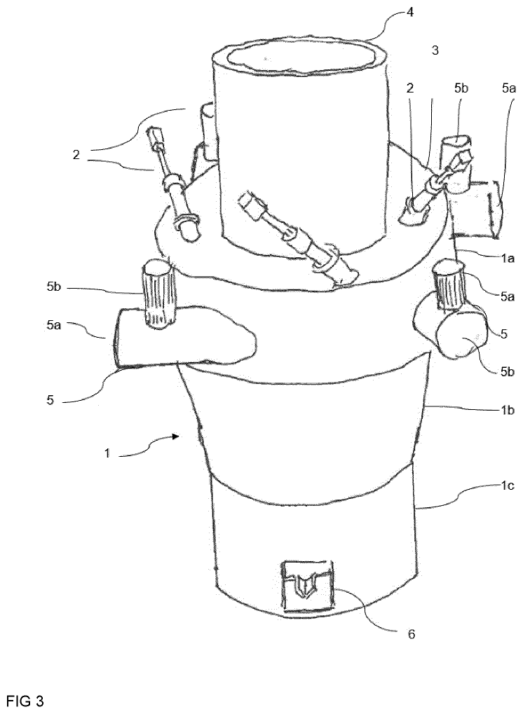

FIG. 3 shows a schematic of the exterior of the furnace 1. The generally cylindrical top section 1a, the generally frustoconical central section 1b and the generally cylindrical bottom section 1c are shown. The ports 5 for mineral raw material and oxidising agent and the ports 2 for gaseous fuel are located at the top of the furnace 1. Specifically, the gaseous fuel ports 2 traverse the furnace lid 3 and the ports 5 for mineral raw material and oxidising agent traverse the side body wall of the top section 1a of the furnace 1.

Additional heating apparatus such as further burners or electrodes can be implemented in the central section 1b and/or in the bottom section 1c, to heat and refine the melted mineral material. However, the primary fuel source is gaseous fuel and the energy to melt the mineral material is provided by the gaseous fuel that is injected at or near the top of the furnace 1.

In the bottom section 1c, an outlet 6 is provided for the mineral melt. In FIG. 3, the outlet 6 takes the form of a siphon. The outlet 6 could alternatively be provided in the base of the furnace 1 (not shown).

The mineral melt may be transported to a fiberizing apparatus such as internal centrifugation (spinning cup) or external centrifugation (cascade spinner) apparatus. There the mineral melt is converted into fibres in conventional manner and can then be formed into mineral fibre products, also in conventional manner.

1. A method of making mineral melt, the method comprising:
providing a cyclone furnace, particulate mineral raw material, gaseous fuel, and oxidising agent;
injecting gaseous fuel into the furnace at one or more first injection ports;
injecting oxidising agent into the furnace at one or more second injection ports;
injecting mineral raw material into the furnace at one or more third injection ports,
wherein the gaseous fuel, oxidising agent and mineral raw material are all injected into the top of the furnace; and
allowing the gaseous fuel to combust with the oxidising agent, thereby melting the mineral raw material,
wherein each first injection port is spaced at an angular separation from the one or more second injection ports such that no first injection port is at an angular separation of less than 20 degrees from any of the second injection ports, measured about a vertical axis through the centre of the cyclone furnace.

2. The method according to claim 1, wherein each second injection port is integrated with a third injection port.

3. The method according to claim 1, wherein each first injection port is spaced at an angular separation from the one or more third injection ports such that no first injection port is at an angular separation of less than 20 degrees from any of the third injection ports, measured about a vertical axis through the centre of the cyclone furnace.

4. The method according to claim 1, to claim wherein the gaseous fuel injected through the one or more first injection ports provides at least 40% of the energy in the furnace, preferably at least 50%.

5. The method according to claim 1, wherein the furnace comprises a body and a lid and wherein the first injection ports traverse the lid.

6. The method according to claim 1, wherein the furnace comprises a body having a body wall and a lid, the body comprising a top section, a central section and a bottom section, wherein the second and third injection ports traverse the top section of the body wall.

7. The method according to claim 5, wherein each of the one or more first injection ports is positioned at an angle of from 30 to 90 degrees from the lid of the furnace.

8. The method according to claim 1, wherein the mineral raw material has a composition in wt % of:
SiO₂: 30 to 51;
Al₂O₃: at least 14, 15, 16 or 18, not more than 35, 30, 26 or 23;
CaO: 8 to 30;
MgO: 2 to 25;
FeO (including Fe₂O₃): 4 to 15;
FeO+MgO: 10 to 30;
Na₂O+K₂O: up to 10;
CaO+Na₂O+K₂O: 10 to 30;
TiO₂: up to 6;
TiO₂+FeO: 4 to 18;
B₂O₃: up to 5;
P₂O₅: up to 8; and
others: up to 8.

9. The method according to claim 1, wherein the oxidising agent is air, oxygen, or oxygen-enriched air, preferably oxygen-enriched air.

10. A cyclone furnace for melting mineral raw material, the cyclone furnace comprising:
a furnace body;
a furnace lid;
one or more first injection ports for injecting gaseous fuel into the furnace;
one or more second injection ports for injecting oxidising agent into the furnace; and
one or more third injection ports for injecting mineral raw material into the furnace,
wherein the furnace body comprises a top section, a central section and a bottom section, each first injection port is spaced at an angular separation from the one or more second injection ports such that no first injection port is at an angular separation of less than 20 degrees from any of the second injection ports, measured about a vertical axis through the centre of the cyclone furnace, and
wherein each of the first, second and third injection ports are configured to inject the gaseous fuel, oxidising agent and mineral raw material, respectively, into the top of the furnace.

11. The cyclone furnace according to claim 10, wherein each second injection port is integrated with a third injection port.

12. The cyclone furnace according to claim 10, wherein each first injection port is spaced at an angular separation from the one or more third injection ports such that no first injection port is at an angular separation of less than 20 degrees from any of the third injection ports, measured about a vertical axis through the centre of the cyclone furnace.

13. The cyclone furnace according to claim 10, wherein the furnace comprises a body wall and a lid and wherein the first injection ports traverse the lid.

14. The cyclone furnace according to claim 13, wherein each of the one or more first injection ports is positioned at an angle of from 30 to 90 degrees from the lid of the furnace.

15. The cyclone furnace according to claim 10, wherein the furnace comprises a body wall and a lid, the body wall comprising a top section, a central section and a bottom section, wherein the second and third injection ports traverse the top section of the body wall.
